(19) United States
(12) Patent Application Publication
(10) Pub. No.: US 2025/0322125 A1
(43) Pub. Date: Oct. 16, 2025

(54) METHOD, ELECTRONIC DEVICE, AND PROGRAM PRODUCT FOR DETERMINING COMPUTATIONAL FLUID DYNAMICS DATA

(71) Applicant: Dell Products L.P., Round Rock, TX (US)

(72) Inventors: Qiang Chen, Shanghai (CN); Pedro Fernandez Orellana, Surfers Paradise (AU)

(21) Appl. No.: 18/651,310

(22) Filed: Apr. 30, 2024

(30) Foreign Application Priority Data
Apr. 11, 2024 (CN) 202410437415.9

(51) Int. Cl. G06F 30/28; G06F 30/27

(52) U.S. Cl. CPC G06F 30/28; G06F 30/27

(57) ABSTRACT

Embodiments of the present disclosure provide a method, an electronic device, and a computer program product for determining computational fluid dynamics (CFD) data. The method includes acquiring a spatial coordinate set associated with a target object. The method further includes determining a location coded set associated with the spatial coordinate set. The method further includes determining CFD data associated with the target object by using a machine learning model based on the location coded set, wherein a sample spatial coordinate set associated with training of the machine learning model includes a plurality of sample spatial coordinate subsets acquired through uniform spatial sampling. In this way, the cost of acquiring CFD data can be reduced and the speed of acquiring the CFD data can be improved.

### RELATED APPLICATION

The present application claims priority to Chinese Patent Application No. 202410437415.9, filed Apr. 11, 2024, and entitled “Method, Electronic Device, and Program Product for Determining Computational Fluid Dynamics Data,” which is incorporated by reference herein in its entirety.

### FIELD

Embodiments of the present disclosure relate to the field of electronic devices, and more specifically, to a method, an electronic device, and a computer program product for determining computational fluid dynamics data.

### BACKGROUND

Computational fluid dynamics (CFD) is a commonly used method for verifying and optimizing a thermal design of an information technology (IT) device. CFD allows an engineer to conduct comprehensive analysis of the thermal design. Compared with using an experimental apparatus, using CFD simulation has higher flexibility and lower cost. CFD simulations are mainly managed and used by a small group of experienced engineers in the thermotics field, as they require knowledge in specific fields; however, many researchers in non-thermotics fields are also interested in the thermal performance (such as airflow patterns and hotspots in a chassis) acquired through the CFD simulations.

### SUMMARY

Embodiments of the present disclosure provide a solution for determining CFD data.

In a first aspect of the present disclosure, a method for determining CFD data is provided. The method includes acquiring a spatial coordinate set associated with a target object. The method further includes determining a location coded set associated with the spatial coordinate set. The method further includes determining the CFD data associated with the target object by using a machine learning model based on the location coded set, wherein a sample spatial coordinate set associated with training of the machine learning model includes a plurality of sample spatial coordinate subsets acquired through uniform spatial sampling.

In a second aspect of the present disclosure, an electronic device is provided. The electronic device includes at least one processor and a memory coupled to the at least one processor. The memory has instructions stored therein, and the instructions, when executed by the at least one processor, cause the electronic device to perform actions. The actions include acquiring a spatial coordinate set associated with a target object. The actions further include determining a location coded set associated with the spatial coordinate set. The actions further include determining CFD data associated with the target object by using a machine learning model based on the location coded set, wherein a sample spatial coordinate set associated with training of the machine learning model includes a plurality of sample spatial coordinate subsets acquired through uniform spatial sampling.

In a third aspect of the present disclosure, a computer program product is provided. The computer program product is tangibly stored on a non-transitory computer-readable medium and includes machine-executable instructions, wherein the machine-executable instructions, when executed by a machine, cause the machine to perform actions. The actions include acquiring a spatial coordinate set associated with a target object. The actions further include determining a location coded set associated with the spatial coordinate set. The actions further include determining CFD data associated with the target object by using a machine learning model based on the location coded set, wherein a sample spatial coordinate set associated with training of the machine learning model includes a plurality of sample spatial coordinate subsets acquired through uniform spatial sampling.

This Summary is provided to introduce the selection of concepts in a simplified form, which will be further described in the Detailed Description below. The Summary is neither intended to identify key features or main features of the present disclosure, nor intended to limit the scope of the present disclosure.

### BRIEF DESCRIPTION OF THE DRAWINGS

By more detailed description of exemplary embodiments of the present disclosure, provided herein with reference to the accompanying drawings, the above and other objectives, features, and advantages of the present disclosure will become more apparent, wherein identical reference numerals generally represent identical components in the exemplary embodiments of the present disclosure. In the accompanying drawings:

FIG. 1 is a schematic diagram of an example environment in which embodiments of the present disclosure can be implemented;

FIG. 2 is a schematic diagram of performing CFD simulation on a server chassis;

FIG. 3 is a schematic diagram of post-processing analysis of CFD data;

FIG. 4 is a schematic diagram of temperature distribution inside a server chassis;

FIG. 5 is a flowchart of an example method for determining CFD data according to an embodiment of the present disclosure;

FIG. 6 is a block diagram of training a machine learning model according to an embodiment of the present disclosure;

FIG. 7 is a schematic diagram of uniform sampling according to an embodiment of the present disclosure;

FIG. 8 is a schematic diagram of comparison between a Halton sequence and a pseudo-random sequence according to an embodiment of the present disclosure;

FIG. 9 is a block diagram of an architecture of a machine learning model according to an embodiment of the present disclosure;

FIG. 10 is a schematic diagram of a query according to an embodiment of the present disclosure; and

FIG. 11 is a block diagram of an example device that can be configured to implement embodiments of the present disclosure.

### DETAILED DESCRIPTION

Principles of the present disclosure will be described below with reference to several example embodiments illustrated in the accompanying drawings. Although the drawings show illustrative embodiments of the present disclosure, it should be understood that these embodiments are merely described to enable those skilled in the art to better understand and further implement the present disclosure, and not in any way to limit the scope of the present disclosure.

The term “include” and variants thereof used herein indicate open-ended inclusion, that is, “including but not limited to.” Unless specifically stated, the term “or” means “and/or.” The term “based on” means “based at least in part on.” The terms “an example embodiment” and “an embodiment” indicate “at least one example embodiment.” The term “another embodiment” indicates “at least one additional embodiment.” The terms “first,” “second,” and the like may refer to different or the same objects. Other explicit and implicit definitions may also be included below.

As described above, many researchers in non-thermotics fields are also interested in the thermal performance (such as airflow patterns and hotspots in a chassis) acquired through CFD simulations, for example, engineers designing IT devices (such as server chassis). Due to the complex geometric shapes and thermal conditions of most IT devices, CFD simulations often require large-scale grids to analyze geometric shapes with sufficient details. Therefore, simulation data is often very large, and tens of gigabytes (GB) of CFD simulation result files are common, which leads to high processing and storage costs for CFD simulation results. The large amount of CFD data poses significant obstacles when sharing results with non-CFD personnel (sometimes even between CFD personnel). The analysis of CFD data further requires specific post-processing software and related knowledge, which poses many limitations to potential audiences, such that the CFD simulations are difficult to share and collaborate on. In addition, the CFD data has redundancy, but compression is difficult.

A solution for determining CFD data is provided in embodiments of the present disclosure to solve the above problem and one or more of other potential problems. This solution utilizes machine learning models, considers high-frequency features and other features of CFD data, and utilizes a uniform spatial sampling training method to achieve efficiency and validity in imbalanced raw CFD data. In this way, reduction and compression of the data volume of the CFD data can be achieved, thereby achieving flexible interpolation and analysis. In some embodiments, this solution can further provide a query method for analyzing any CFD data. In some embodiments, the disclosed solution can not only achieve significant data reduction with minimal accuracy loss, but also reduce friction when using CFD data, so that it is easier for non-CFD personnel to access them, which opens the door to advanced applications such as digital twins in IT devices.

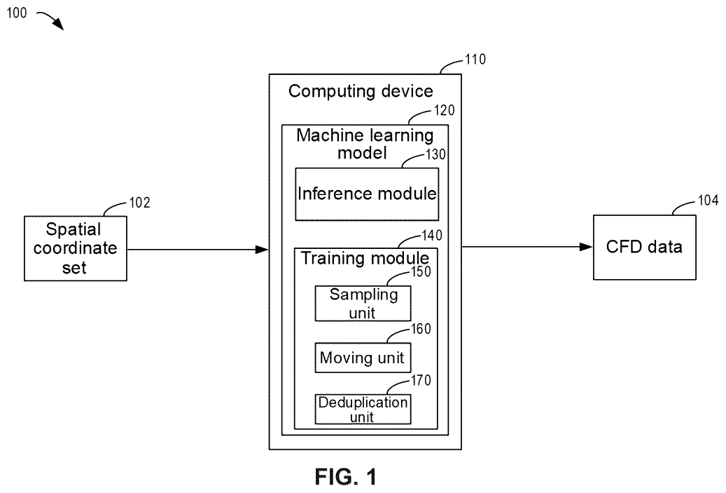

FIG. 1 shows a schematic diagram of an example environment 100 in which embodiments of the present disclosure can be implemented. As shown in FIG. 1, the example environment 100 includes a computing device 110. The computing device 110 may include, for example, a laptop, a television, a smartphone, a tablet, and a desktop computer, and the present disclosure is not intended to limit this. The computing device 110 may include a machine learning model 120. For example, the machine learning model 120 may be installed on the computing device 110.

The machine learning model 120 may include a plurality of modules. For example, these modules may include an inference module 130 and a training module 140. The training module 140 may be configured to train the machine learning model 120. The inference module 130 may be configured to generate required CFD data in practical use. The training module 140 may include a sampling unit 150, a moving unit 160, and a deduplication unit 170. The sampling unit 150 may be configured to uniformly sample a batch of sample data during training. The moving unit 160 may be configured to further determine which data should be selected for the training process. The deduplication unit 170 may be configured to remove duplicate sampling data.

The machine learning model 120 may acquire a spatial coordinate set 102 of a target object (such as a server chassis). The machine learning model 120 may use the spatial coordinate set 102 to generate corresponding CFD data 104 (also referred to as first CFD data), such as temperature, velocity, and pressure. The machine learning model 120 may also acquire a query for the target object and output CFD data for the query. The machine learning model 120 may further acquire another large amount of CFD data (also referred to as second CFD data) and output compressed CFD data.

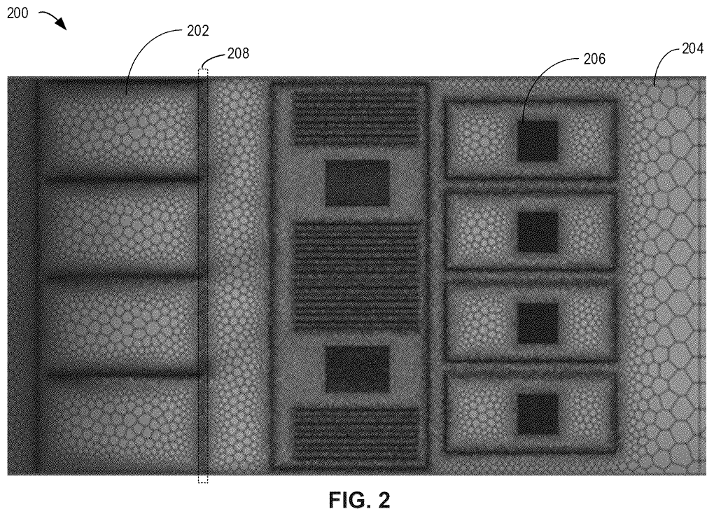

FIG. 2 is a schematic diagram of performing CFD simulation 200 on a server chassis. In FIG. 2, a top view of grids used for CFD simulating of the server chassis is shown. Firstly, the grids of CFD simulation are introduced. Validation and optimization of thermal design are important steps in designing an IT device. Experimental and numerical methods are two main methods used in the field. Numerical simulation performed on the IT device using the CFD is a widely used detailed thermal analysis method. Compared with experiments, the CFD has some advantages, such as not requiring a testing device (such as a hot chamber) and being able to acquire a result faster. The CFD solves a Navier-Stokes equation (for controlling fluid flow) and an energy equation (for controlling heat transfer) based on a numerical method. The basic CFD process includes first creating grids to discretize a simulation domain, then initializing each cell within the grids with some values of each simulated physical variable, and then iterating numerically on the grids until convergence criteria are met. The process is usually completed in specialized CFD software and may be very expensive to use in enterprises.

For example, as shown in FIG. 2, the distribution of the grids in space is not uniform. In a region with a low variance, the grids are very sparse (for example, at a region 204). But in certain parts (such as regions 202 and 208 near the wall), they are very dense (where there may be significant gradients in fluid velocity and temperature). Places similar to a region 206 are places where physical devices such as chips exist. This non-uniformity of grids is crucial for achieving sufficient numerical accuracy.

After numerical iteration convergence, simulation results are saved to a certain “data file.” Although an exact file format may vary depending on CFD software used, the content is very similar. It includes values of all simulated physical variables (such as velocity, pressure, temperature, and turbulence variables) at each unit or node in the grid. An actual thermal simulation model of a product may have hundreds of millions of units, so the data file may also be large, easily reaching tens of GB.

Engineers may perform various analyses using the saved data file. This is usually achieved through the use of a built-in post-processing module in commercial CFD software or some specialized software. This is rarely done from scratch, as it typically involves some degree of interpolation from the original grids to a desired subspace, such as drawing temperature profiles for certain cutting surfaces, which requires relevant professional knowledge.

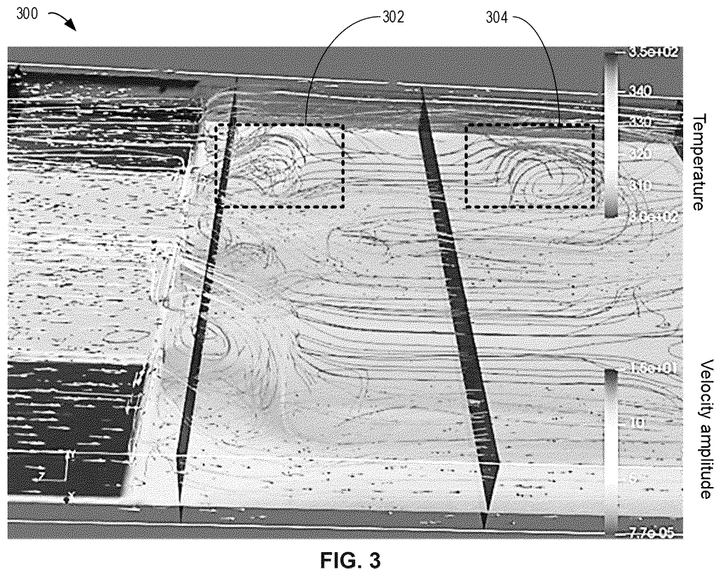

FIG. 3 is a schematic diagram of post-processing analysis 300 of CFD data. FIG. 3 shows an analysis result using a certain type of commercial software for analyzing and visualizing CFD simulations. FIG. 3 integrates information from a plurality of dimensions, including airflow (represented by lines and displaying flow paths) and temperature (represented by different grayscales). For example, in block 302 and block 304, there is a vortex generated by the flow of the air. It is not difficult to understand that setting up and running CFD simulations require extensive domain knowledge. The information shown in FIG. 3 may also be helpful for mechanical engineers, or it may be an advanced function as part of a software kit sold together with hardware. Although it has aroused widespread interest, there are still many issues that are problematic in the current access methods for CFD simulations.

One issue is the high processing and storage costs of CFD simulation results. As mentioned earlier, the CFD simulations, especially simulations of IT devices, typically run on large grids and are therefore saved in very large data files. For example, a simplified server model has 2.5 million grids and exports ASCII data in a size of 300 MB with 5 variables. A certain model has 172 million grids and is exported as a file in a size of 18 GB. The size of data files makes storing and processing CFD simulation results costly. There are also some other indirect but related issues. For example, loading data may take tens of minutes, and loading data alone may consume a storage in a size of hundreds of GB (which most people cannot use), and even running any type of analysis may be slower.

Another issue is that CFD simulations are difficult to share and collaborate on. The above problem may still be solved by professional CFD engineers, who may regularly access powerful workstations or computer clusters (although the cost is high). However, considering that many non-CFD personnel are interested in the thermal performance of IT devices, many people hope to collaborate through CFD simulation. However, the current reality is that: due to the large size of files, the cost of sharing data is high; professional software (CFD software or post-processing software) is required for processing, and commercial software is usually very expensive; and the existing toolchain is inflexible, requiring domain knowledge, extensive coding, and high concentration to manually interpolate from original grids and create custom drawings/monitors.

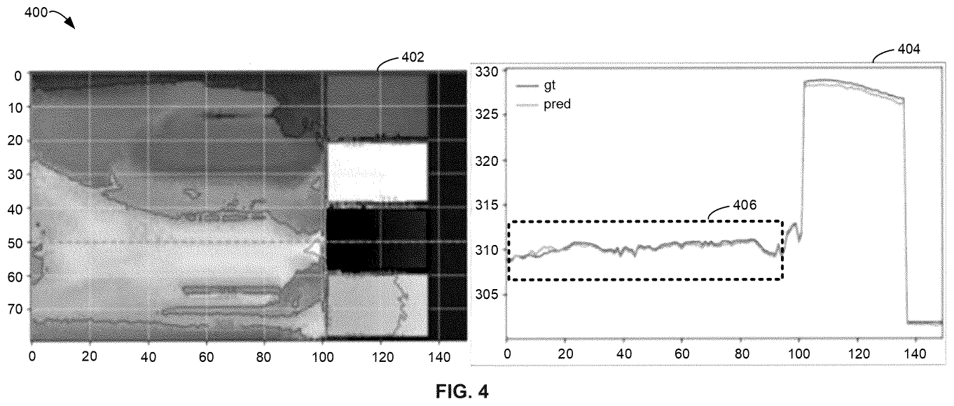

In addition, another issue is the redundancy of CFD data, which is difficult to reduce and compress. For example, FIG. 4 is a schematic diagram of temperature distribution 400 inside a server chassis. FIG. 4 may be understood as an example of the temperature distribution inside the server chassis for each hard drive under different workloads. A left subfigure 402 shows the temperature profile of a certain cross-section, while a right subfigure 404 shows the temperature profile along a certain line in a plane. These may clearly indicate that physical variables may exhibit complex patterns that are difficult to describe with simple functions. But it may also be seen that by eliminating the redundancy within the data, the size of CFD simulations may be reduced. The redundant data (such as in block 406) exists in parts where values vary through simple patterns (such as linear or quadratic functions). In this case, a large number of floating points stored in grid cells may be replaced by functions fitted from the data. Although theoretically possible, the characteristics of the CFD simulation make it difficult to compress the CFD data.

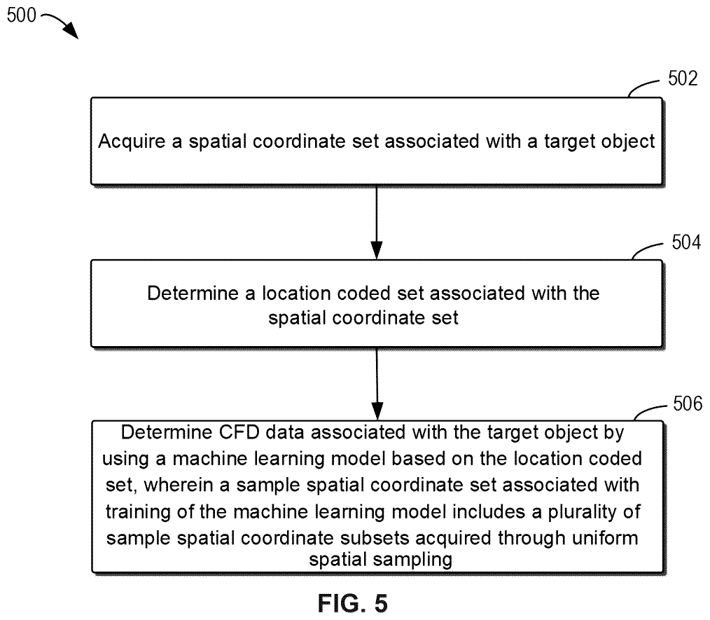

The solution for determining CFD data according to the present disclosure will be described below in detail with reference to FIG. 5 to FIG. 10. The solution of the present disclosure can overcome the above three problematic issues, and possibly other additional or alternative problems of conventional approaches, by converting massive CFD simulation data into a more compact deep neural network.

FIG. 5 is a flowchart of an example method 500 for determining CFD data according to an embodiment of the present disclosure. The method 500 may be performed by, for example, the computing device 110 in FIG. 1. At block 502, a spatial coordinate set associated with a target object is acquired. For example, an initial data preparation step is performed to convert a software specific data format into a more structured tensor format.

At block 504, a location coded set associated with the spatial coordinate set is determined. For example, similar to the idea of a Transformer model, location information of the target object is encoded. In some embodiments, the location encoding function here may be similar to a function used in a neural radiant field (NeRF), except that a goal here is to learn physical variables associated with the target object rather than a rendering mode.

At block 506, based on the location coded set, the CFD data associated with the target object is determined by using a machine learning model. A sample spatial coordinate set associated with training of the machine learning model includes a plurality of sample spatial coordinate subsets acquired through uniform spatial sampling. For example, the machine learning model 120 may determine one or more of the velocity, temperature, and pressure of the air around the target object. The velocity may include the magnitude and direction of velocities along X, Y, and Z axes in space.

In some embodiments, when the machine learning model 120 is trained, the training data may be used to include a sample spatial coordinate set. The sample spatial coordinate set may include a plurality of sample spatial coordinate subsets. Each sample spatial coordinate subset may include a low-discrepancy sequence. In a training loop, special data sampling (including uniform sampling, movement (also referred to as “snapping”), and duplicate data deletion) may be used to enhance feedforward and backpropagation training steps. The machine learning model 120 may be a deep neural network (DNN), which may utilize CPU/GPU clusters that may be used to run CFD simulations at any time.

In this way, reduction and compression of the data volume of the CFD data can be achieved, thereby achieving flexible interpolation and analysis. Utilizing the machine learning model 120, for example, can consider high-frequency features and other features of CFD data, and a uniform spatial sampling training method is utilized to achieve efficiency and validity in imbalanced raw CFD data.

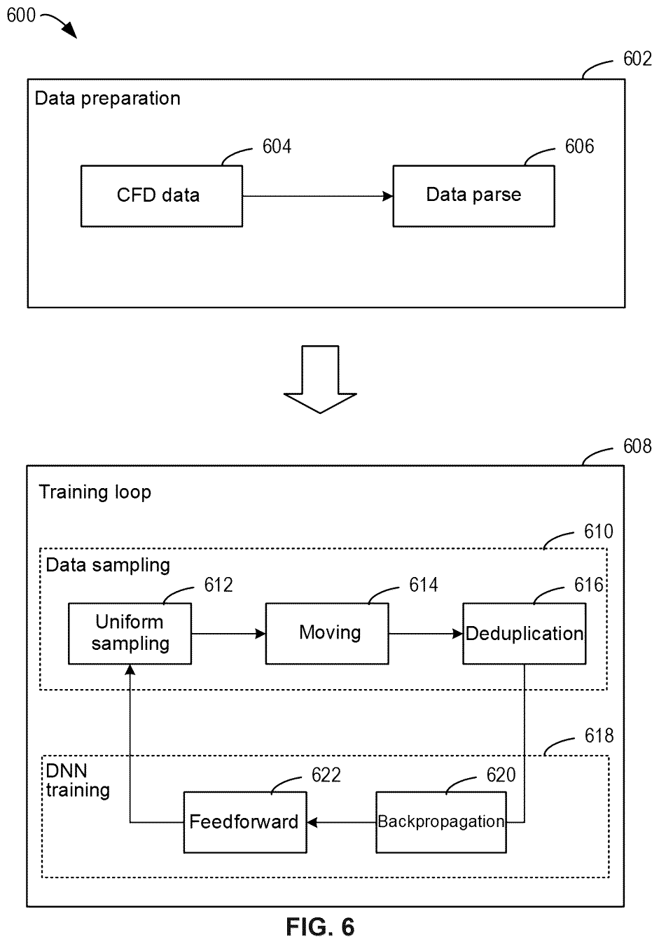

FIG. 6 is a block diagram of training a machine learning model 600 according to an embodiment of the present disclosure. The machine learning model in FIG. 6 may correspond to the machine learning model 120 in FIG. 1. In a data preparation stage 602, CFD data 604 may be acquired and parsed in block 606. For example, a specific format used in commercial software is parsed into a universal format to facilitate structured storage in a tensor format, and the like.

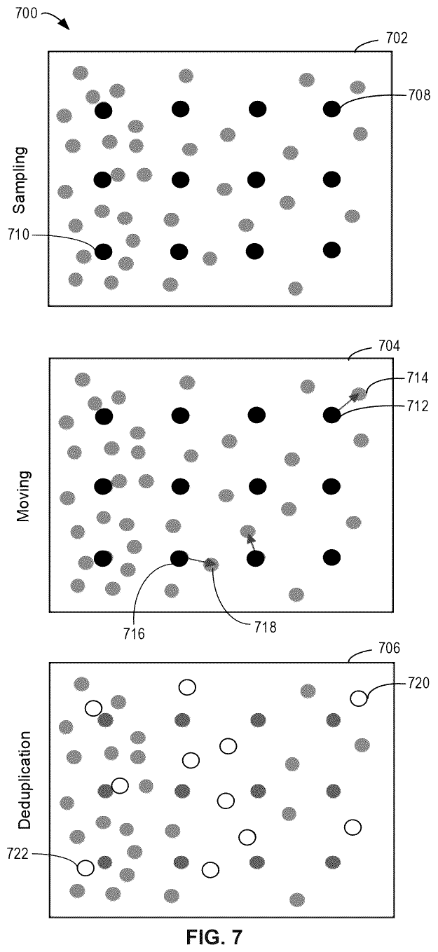

The parsed CFD data 604 may be input into a training loop module 608. The training loop module 608 in FIG. 6 may correspond to the training module 140 in FIG. 1. Data sampling is implemented in block 610. Specifically, in block 612, uniform spatial sampling (which may be interchanged with uniform sampling herein) is performed on the training data. In block 614, the preliminary sampled data is moved (also referred to as “snapped”). In block 616, the sampled data is deduplicated. The specific description of the block 610 may be obtained with reference to FIG. 7 below.

FIG. 7 is a schematic diagram of uniform sampling 700 according to an embodiment of the present disclosure. In fact, the coordinates are located in a 3D space, but for illustrative purposes, only 2D examples are shown here. Grey dots represent non-uniformly distributed unit/node data (assuming it comes from CFD simulation). Firstly, in subfigure 702, some uniformly distributed points (such as black dots 708 and 710) are generated in the same space according to a certain sequence. In some embodiments, a certain type of low-discrepancy sequence, such as a Halton sequence, may be used. They allow for the introduction of randomness in each iteration, so that all points have the same probability of being selected in each iteration, while also having better characteristics of selecting points with a more uniform distribution.

Then, in subfigure 704, a black origin may be “snapped” to a point nearest to an original non-uniform grid. In some embodiments, it may be effectively implemented through a k-nearest neighbors (KNN) algorithm, wherein k=2. Then, the nearest point, that is, the origin itself, is discard. For example, a black dot 712 may be moved to a gray dot 714, and then the gray dot 714 may be discarded. For example, a black dot 716 may be moved to a gray dot 718, and then the gray dot 718 may be discarded.

Next, in subfigure 706, some black dots may snap the same gray dots, so it is necessary to perform a duplicate data deletion step to avoid generating overlapping points, which may also lead to skewed data distribution. The finally selected points may be marked as hollow dots in the subfigure 706, such as a dot 720 and a dot 722.

Now returning to FIG. 6, after the steps of sampling+snapping+deduplication, the original grid with highly non-uniform distribution in space may be transformed into a sampling subspace with statistically uniform distribution (that is, a sample spatial coordinate subset). In DNN training 618, feedforward 622 and backpropagation 620 are repeated in each training iteration, and different subsets of the original grid data are selected to train the model. Finally, the model will be trained to have good fitting with the original data.

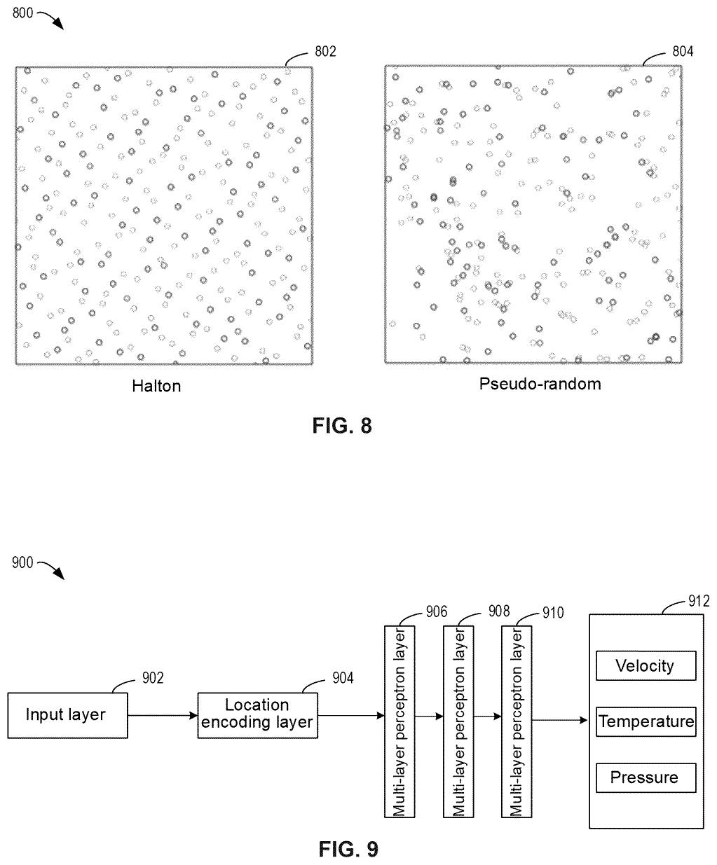

FIG. 8 is a schematic diagram of comparison 800 between a Halton sequence and a pseudo-random sequence according to an embodiment of the present disclosure. In subfigure 802, the points generated using the Halton sequence are shown. In subfigure 804, the points generated using the pseudo-random sequence are shown. As can be seen, the points generated using the pseudo-random sequence are too scattered, so that the training data loses the characteristic of uniform distribution. The use of the Halton sequence allows for the introduction of randomness in each iteration, so that all points have the same probability of being selected in each iteration, while further having the better characteristic of selecting points with a more uniform distribution. In some embodiments, it may also be seen that other sequences with low-discrepancy characteristics are used to generate points, which are not limited in the present disclosure.

FIG. 9 is a block diagram of an architecture of a machine learning model according to an embodiment of the present disclosure. In some embodiments herein, patterns of various physical variables in a flow field and a temperature field are very complex and cannot be easily described with simple functions. More specifically, these physical variables may have both high-frequency and low-frequency features, so that the two are both difficult to learn. Therefore, the solution illustrated in FIG. 9 provides a special DNN architecture 900. An input of the DNN architecture 900 is spatial coordinates that may be input into an input layer 902, and an output is physical variables (such as temperature, three velocities of the XYZ axis, and pressure). After the input layer 902, a location encoding layer 904 follows. The location encoding layer 904 is crucial for learning high-frequency modes in the flow/temperature field. The idea of the locational encoding is popularized by a Transformer and for encoding locational information of language markers. But the location encoding layer 904 in the DNN architecture 900 has a location encoding function that is more similar to the function used in NeRF, except that the goal here is to learn physical variables rather than a rendering mode.

After the location encoding layer 904, there are a plurality of repeated multi-layer perceptron (MLP) layers 906, 908, and 910. Each MLP has a residual connection and normalization layer to ensure smooth gradient flow and case of training. For example, an MLP has 1024 neurons in 4 layers, with the residual connection and normalization layer. The number of the MLP layers may be increased or decreased as needed, which is not limited in the present disclosure. The output layer 912 is connected to the last MLP layer and may output CFD data such as velocity, temperature, and pressure.

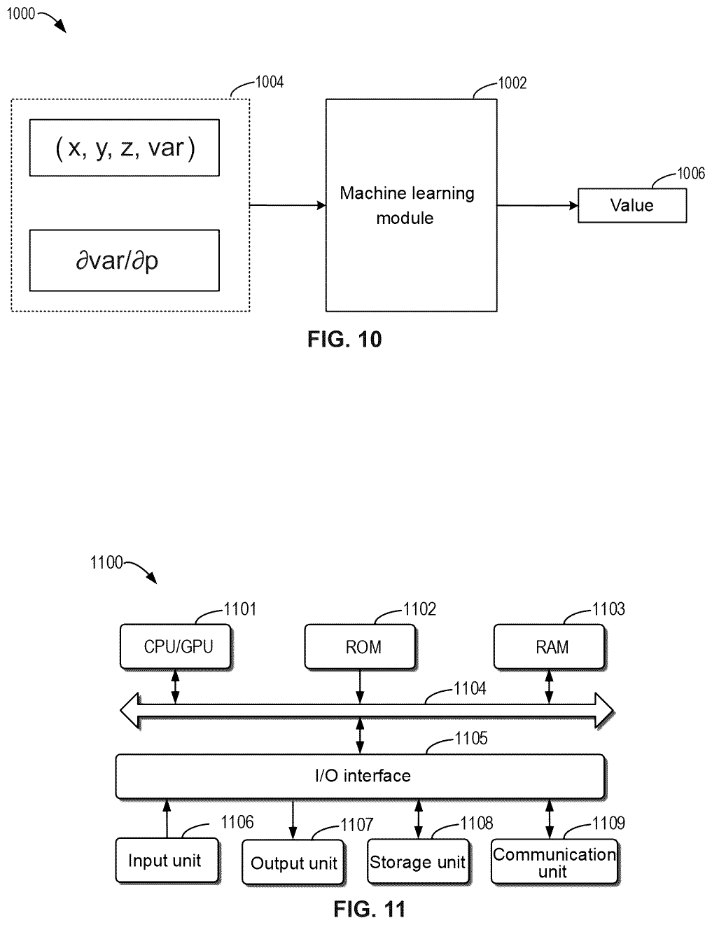

FIG. 10 is a schematic diagram of a query 1000 according to an embodiment of the present disclosure. A scenario described in FIG. 10 is: a user may use various query routines to obtain an output, that is, use a DNN that encodes information from original CFD simulation. In most cases, some custom queries based on the following content may be used: basic “point queries.” For example, if it is intended to know the temperature distribution of a key cross-section, a query may be performed along that plane to acquire values without performing interpolation on the original data. This is because the fact that CFD data is encoded in the neural network also opens the door to advanced analysis using an automatic differentiation function within a neural network engine (such as TensorFlow and PyTorch). For example, a gradient-based optimizer may be used to find the minimum/maximum value in the space, which takes advantage of the characteristic that the neural network can output a partial derivative (differential value) of the parameter p. The query 1004 may include spatial coordinates x, y, z of the target location, as well as target variables. If the specific location of the query 1004 is included in the spatial coordinate set, a value 1006 of the corresponding CFD data is directly output. If the specific location of the query 1004 is not in the spatial coordinate set, the machine learning model 1002 may be used to determine the value 1006 of CFD data corresponding to the specific location.

In summary, the design and architecture of the DNN in this solution are advantageous, including the use of coordinates as input and output physical variables, location encoding, and MLP layers with residual connection and normalization layers, which are crucial for achieving good fitting with the original CFD simulation data.

Due to the uneven height of out of box unit or node data in the CFD, it is necessary to ensure the accuracy of the numerical solver. However, the data is not suitable for training the machine learning model because imbalanced data in spatial coordinates may greatly distort machine learning training, resulting in the lower fitting accuracy. In the testing of this solution, if there is no uniform spatial sampling, the relative error of the model evaluated on a validation set is higher than 5%. However, by using the sampling method of this solution, the error may be reduced to a range of about 1%. The uniform sampling method may be a key factor in achieving the high accuracy.

The core of CFD simulation data is a physical variable value of each unit/node. The post-processing software integrates, based on this type of data, automatic interpolations of discrete data and generates arbitrary outputs. The analysis of the CFD data is achieved through post-processing software. This solution eliminates this complexity from its core by directly allowing the query of physical variables at any coordinate. This function makes it easy to expand to all types of queries without interpolation. The ability of querying derivatives of certain parameters may also achieve advanced functions that may not be able to achieve using the original CFD data.

In some embodiments, this solution may also achieve compression of CFD data, and may achieve a significant reduction in file size without losing too much information. For example, in some testing tests, a simplified server model with 2.5 million units exports ASCII data with 5 variables (x, y, z-axis velocity, temperature, pressure) and a data size of 350 MB. This solution may convert the data in the size of 350 MB into a DNN file in the size of 6 MB. An overall error range (measured by comparing a generated value with an original value) is approximately 1%. In similar tests of production level simulation models, for an ANSYS Fluent model of PowerEdge R650, the model has approximately 172 million units and exports an ASCII file containing 5 variables in the size of approximately 20 GB. This solution can convert a file in the size of 20 GB to approximately 500 MB with an overall error range of 1%.

Therefore, by using this solution, instead of directly storing numerical data, a specially designed neural network may be used to learn and reconstruct original data, only storing parameters and architecture of the neural network. As a result, this solution achieves a higher compression ratio with very little accuracy loss. After CFD simulation is completed, using this solution on the same infrastructure (such as a CPU/GPU cluster) may generate a smaller DNN file. When CFD data needs to be shared, only a small file and a simple analysis script created by a CFD engineer are shared. The user may flexibly use the given script to reproduce key CFD insights, or customize any analysis in the script that is not provided, without the need to install commercial software or return it to the CFD engineer.

In addition, since there is no explicit stream data stored, this solution uses a point-based query mechanism to generate the required data. This is an advantageous CFD data analysis method. It also brings benefits such as not relying on expensive CFD software, greatly reducing hardware requirements for analysis (for example, a traditional server CFD model may require a memory in the size of over 100 GB to load data, while this solution only requires dozens of or hundreds of MB), and the like.

FIG. 11 shows a block diagram of an example device 1100 that may be configured to implement embodiments of the present disclosure. As shown in the FIG. 11, the device 1100 includes a central processing unit and/or a graphics processing unit (CPU/GPU) 1101 that may perform various appropriate actions and processing according to computer program instructions stored in a read-only memory (ROM) 1102 or computer program instructions loaded from a storage unit 1108 to a random access memory (RAM) 1103. Various programs and data required for the operation of the device 1100 may also be stored in the RAM 1103. The CPU/GPU 1101, the ROM 1102, and the RAM 1103 are connected to each other through a bus 1104. An input/output (I/O) interface 1105 is also connected to the bus 1104.

A plurality of components in the device 1100 are connected to the I/O interface 1105, including: an input unit 1106, such as a keyboard and a mouse; an output unit 1107, such as various types of displays and speakers; the storage unit 1108, such as a magnetic disk and an optical disc; and a communication unit 1109, such as a network card, a modem, and a wireless communication transceiver. The communication unit 1109 allows the device 1100 to exchange information/data with other devices through a computer network such as the Internet and/or various telecommunication networks.

The processes and processing described above, such as the method 500, may be performed by CPU/GPU 1101. For example, in some embodiments, the method 500 may be implemented as a computer software program that is tangibly included in a machine-readable medium, such as the storage unit 1108. In some embodiments, part or all of the computer program may be loaded and/or installed to the device 1100 via the ROM 1102 and/or the communication unit 1109. When the computer program is loaded into the RAM 1103 and executed by the CPU/GPU 1101, one or more actions of the method 500 described above may be implemented.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein can be downloaded from a computer-readable storage medium to various computing/processing devices, or downloaded to an external computer or external storage device through a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

Computer program instructions for performing the operations of the present disclosure may be assembly instructions, Instruction Set Architecture (ISA) instructions, machine instructions, machine-related instructions, microcode, firmware instructions, state setting data, or source code or object code written in any combination of one or more programming languages, including object-oriented programming languages such as Smalltalk and C++, and conventional procedural programming languages such as “C” language or the like. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flowcharts and/or block diagrams of the method, apparatus (system), and computer program product according to embodiments of the present disclosure. It should be understood that each block of the flowcharts and/or the block diagrams and combinations of blocks in the flowcharts and/or the block diagrams may be implemented by the computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, produce means for implementing the functions/acts specified in one or more blocks in the flowcharts and/or block diagrams. These computer-readable program instructions may also be stored in a computer-readable storage medium, and cause a computer, a programmable data processing apparatus, and/or other devices to function in a particular manner, so that the computer-readable medium having the instructions stored thereon includes an article of manufacture including instructions for implementing various aspects of the functions/acts specified in one or more blocks in the flowcharts and/or block diagrams.

The computer-readable program instructions may also be loaded onto a computer, other programmable data processing apparatuses, or other devices, such that a series of operational steps are performed on the computer, other programmable data processing apparatuses, or other devices to produce a computer-implemented process, such that the instructions executed on the computer, other programmable data processing apparatuses, or other devices implement the functions/actions specified in one or more blocks in the flowcharts and/or block diagrams.

The flowcharts and block diagrams in the drawings illustrate the architectures, functions, and operations of possible implementations of the systems, methods, and computer program products according to various embodiments of the present disclosure. In this regard, each block in the flowcharts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on the involved functions. It should be further noted that each block in the block diagrams and/or flowcharts as well as a combination of blocks in the block diagrams and/or flowcharts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The terminology used herein is chosen to best explain the principles and practical application of various embodiments and their associated technical improvements, so as to enable persons of ordinary skill in the art to understand various embodiments disclosed herein.

What is claimed is:

1. A method for determining computational fluid dynamics (CFD) data, comprising:
acquiring a spatial coordinate set associated with a target object;
determining a location coded set associated with the spatial coordinate set; and
determining CFD data associated with the target object by using a machine learning model based on the location coded set, wherein a sample spatial coordinate set associated with training of the machine learning model comprises a plurality of sample spatial coordinate subsets acquired through uniform spatial sampling.

2. The method according to claim 1, wherein each sample spatial coordinate subset comprises a sequence, a difference between distribution of a plurality of sample spatial coordinates in each sequence and a uniform distribution is optimized to meet a threshold condition, and the threshold condition comprises:
minimizing the difference between the distribution of the plurality of sample spatial coordinates in each sequence and the uniform distribution; and
the method further comprises:
training the machine learning model based on a plurality of sequences that meet the minimization.

3. The method according to claim 1, wherein sampling the sample spatial coordinate set into a plurality of sample space subsets comprising a plurality of sequences comprises:
generating a uniformly distributed first seed coordinate set in a space where the target object is located;
selecting, in the spatial coordinate set, a plurality of corresponding coordinates nearest to a plurality of coordinates in the first seed coordinate set, wherein each corresponding coordinate corresponds to a coordinate in the first seed coordinate set; and
determining the selected plurality of corresponding coordinates as a first sequence to serve as a first sample space subset.

4. The method according to claim 3, wherein selecting, in the spatial coordinate set, a coordinate nearest to each coordinate in the first seed coordinate set respectively comprises:
moving, by using a k-nearest neighbors (KNN) algorithm, each seed coordinate in the first seed coordinate set to its nearest corresponding coordinate in the spatial coordinate set;
deduplicating duplicated coordinates in response to duplication between the corresponding coordinates in the spatial coordinate set; and
determining the first sample space subset based on a plurality of coordinates after deduplication.

5. The method according to claim 3, further comprising:
generating, in the space where the target object is located, a second seed coordinate set that is uniformly distributed and different from the first seed coordinate set;
selecting, in the spatial coordinate set, a plurality of corresponding coordinates nearest to a plurality of coordinates in the second seed coordinate set, wherein each corresponding coordinate corresponds to a coordinate in the second seed coordinate set; and
determining the selected plurality of corresponding coordinates as a second sequence to serve as a second sample space subset.

6. The method according to claim 5, further comprising:
training the machine learning model based on the first sample space subset and the second sample space subset.

7. The method according to claim 1, wherein the CFD data indicates one or more of velocity, temperature, and pressure of air surrounding at least a portion of the target object.

8. The method according to claim 1, further comprising:
acquiring a query for a specific location of the target object;
determining whether the specific location is comprised in the spatial coordinate set;
outputting the corresponding CFD data directly in response to the specific location being comprised in the spatial coordinate set; and
using, in response to the specific location being not comprised in the spatial coordinate set, the machine learning model to determine the CFD data corresponding to the specific location.

9. The method according to claim 8, further comprising:
receiving a target parameter, wherein the target parameter is used to determine how the CFD data varies with the target parameter;
determining, based on the specific location and the target parameter, a differential value of the CFD data with respect to the parameter variation; and
determining an optimization value of the CFD data based on the differential value.

10. The method according to claim 1, wherein the CFD data is first CFD data, and the method further comprises:
acquiring second CFD data associated with the target object, wherein the size of the second CFD data is larger than that of the first CFD data; and
compressing, based on the second CFD data, the size of the second CFD data using the machine learning model.

11. An electronic device, comprising:
at least one processor; and
a memory coupled to the at least one processor, wherein the memory has instructions stored therein, and the instructions, when executed by the at least one processor, cause the electronic device to perform actions comprising:
acquiring a spatial coordinate set associated with a target object;
determining a location coded set associated with the spatial coordinate set; and
determining computational fluid dynamics (CFD) data associated with the target object by using a machine learning model based on the location coded set, wherein a sample spatial coordinate set associated with training of the machine learning model comprises a plurality of sample spatial coordinate subsets acquired through uniform spatial sampling.

12. The electronic device according to claim 11, wherein each sample spatial coordinate subset comprises a sequence, a difference between distribution of a plurality of sample spatial coordinates in each sequence and a uniform distribution is optimized to meet a threshold condition, and the threshold condition comprises:
minimizing the difference between the distribution of the plurality of sample spatial coordinates in each sequence and the uniform distribution; and
wherein the actions further comprise:
training the machine learning model based on a plurality of sequences that meet the minimization.

13. The electronic device according to claim 11, wherein sampling the sample spatial coordinate set into a plurality of sample space subsets comprising a plurality of sequences comprises:
generating a uniformly distributed first seed coordinate set in a space where the target object is located;
selecting, in the spatial coordinate set, a plurality of corresponding coordinates nearest to a plurality of coordinates in the first seed coordinate set, wherein each corresponding coordinate corresponds to a coordinate in the first seed coordinate set; and
determining the selected plurality of corresponding coordinates as a first sequence to serve as a first sample space subset.

14. The electronic device according to claim 13, wherein selecting, in the spatial coordinate set, a coordinate nearest to each coordinate in the first seed coordinate set respectively comprises:
moving, by using a k-nearest neighbors (KNN) algorithm, each seed coordinate in the first seed coordinate set to its nearest corresponding coordinate in the spatial coordinate set;
deduplicating duplicated coordinates in response to duplication between the corresponding coordinates in the spatial coordinate set; and
determining the first sample space subset based on a plurality of coordinates after deduplication.

15. The electronic device according to claim 13, wherein the actions further comprise:
generating, in the space where the target object is located, a second seed coordinate set that is uniformly distributed and different from the first seed coordinate set;
selecting, in the spatial coordinate set, a plurality of corresponding coordinates nearest to a plurality of coordinates in the second seed coordinate set, wherein each corresponding coordinate corresponds to a coordinate in the second seed coordinate set;
determining the selected plurality of corresponding coordinates as a second sequence to serve as a second sample space subset; and
training the machine learning model based on the first sample space subset and the second sample space subset.

16. The electronic device according to claim 11, wherein the CFD data indicates one or more of velocity, temperature, and pressure of air surrounding at least a portion of the target object.

17. The electronic device according to claim 11, wherein the actions further comprise:
acquiring a query for a specific location of the target object;
determining whether the specific location is comprised in the spatial coordinate set;
outputting the corresponding CFD data directly in response to the specific location being comprised in the spatial coordinate set; and
using, in response to the specific location being not comprised in the spatial coordinate set, the machine learning model to determine the CFD data corresponding to the specific location.

18. The electronic device according to claim 17, wherein the actions further comprise:
receiving a target parameter, wherein the target parameter is used to determine how the CFD data varies with the target parameter;
determining, based on the specific location and the target parameter, a differential value of the CFD data with respect to the parameter variation; and
determining an optimization value of the CFD data based on the differential value.

19. The electronic device according to claim 11, wherein the CFD data is first CFD data, and the actions further comprise:
acquiring second CFD data associated with the target object, wherein the size of the second CFD data is larger than that of the first CFD data; and
compressing, based on the second CFD data, the size of the second CFD data using the machine learning model.

20. A computer program product tangibly stored on a non-transitory computer-readable medium and comprising machine-executable instructions, wherein the machine-executable instructions, when executed by a machine, cause the machine to perform actions comprising:
acquiring a spatial coordinate set associated with a target object;
determining a location coded set associated with the spatial coordinate set; and
determining computational fluid dynamics (CFD) data associated with the target object by using a machine learning model based on the location coded set, wherein a sample spatial coordinate set associated with training of the machine learning model comprises a plurality of sample spatial coordinate subsets acquired through uniform spatial sampling.
